(19) United States
(12) Patent Application Publication
(10) Pub. No.: US 2024/0082898 A1
(43) Pub. Date: Mar. 14, 2024

(54) EXTRUSION WITH SPECIFIABLE OR VARIABLE WALL THICKNESS

(71) Applicant: Battelle Memorial Institute, Richland, WA (US)

(72) Inventors: Brandon Scott Taysom, West Richland, WA (US); Scott A. Whalen, West Richland, WA (US)

(21) Appl. No.: 18/244,814

(22) Filed: Sep. 11, 2023

Related U.S. Application Data
(60) Provisional application No. 63/405,664, filed on Sep. 12, 2022.

(51) Int. Cl. B21C 23/08

(52) U.S. Cl. CPC B21C 23/085; B29C 48/13

(57) ABSTRACT

An extrusion system can establish or adjust a position of a tapered, rotationally fixed mandrel with respect to a die orifice to adjustably establish or vary an extrusion aperture width therebetween. This, in turn, can adjustably establish or vary a wall thickness of a tubular extrusion product formed by the extrusion. A die tool can provide rotational shear force and axial compression force to plasticize a billet material for extrusion. The rotationally fixed mandrel can include a lateral outer dimension that varies along a longitudinal direction to vary an inner boundary of the extrusion aperture in response to movement of the rotationally fixed mandrel with respect to the die tool along the central longitudinal axis.

### CROSS REFERENCE TO RELATED APPLICATION

This application claims priority to and the benefit of U.S. Provisional Application Ser. No. 63/405,664 filed on Sep. 12, 2022, the contents of which are hereby incorporated by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### TECHNICAL FIELD

The present disclosure relates to extrusion technology, such as for performing shear-assisted extrusion with a specifiable or variable wall thickness.

### BACKGROUND

Metal extrusion is a metal-forming manufacturing process in which a cylindrical billet inside a closed cavity is forced to flow through a die aperture. These extruded parts are called “extrudates.” The process was first used to extrude lead pipes. In addition to metals, plastics, and ceramics can also be extruded.

### SUMMARY

Shear assisted extrusion processes (ShAPE) are provided, such as for forming an extrudate with a specifiable or variable extrudate wall thickness. For example, a rotationally fixed mandrel can be located with respect to an extrusion die, such as to form an annular extrusion aperture therebetween. A lateral dimension of the extrusion aperture can be easily established or adjusted, such as to a particular desired inner dimension that corresponds to a mandrel outer diameter that can be varied by adjusting a longitudinal position of the mandrel with respect to the extrusion die (or vice-versa). A billet of a billet material to be extruded can be placed in a container. A portion of the billet material within the container can be extruded through the extrusion aperture in response to a rotational shearing force and an axial extrusion force established at a face of a portion of billet material engaged by the die tool. The particular inner diameter of the extrusion aperture can be established or adjusted by moving the rotationally fixed mandrel or the die tool with respect to the other, either before or during extrusion.

The present techniques of shear-assisted extrusion can be used to form a hollow-profile extrudate of a desired composition from one or more billets. A rotational shearing force and an axial extrusion force can be concurrently applied to the same location on the billet material using the extrusion die face and/or a container holding the billet material. Plasticized billet material can be directed through the extrusion aperture defined between an outer diameter of the mandrel and the extrusion die face. After traversing the extrusion aperture, the plasticized material has been configured into a desired shape and a desired constant or variable thickness that can be specified by the relative location of the tapered portion of the mandrel and the extrusion die face, or a location of at least a portion of the extrusion die face such as a throat, landing, or aperture.

These present techniques can help provide a number of potential advantages. For example, the resulting extrudate can be tubular with a specifiable or even variable inner diameter. The present extrusion techniques can also help form an extrudate that can have better strength, electrical conductivity, corrosion resistance, or less porosity, compared to approaches that do not use a combination of rotational and axial forces to shear-assist the extrusion process. Such characteristics can be obtained at lower temperatures, lower forces, and with lower extrusion force and electrical power as compared to non-shear-assisted processing. The present techniques can be useful in a variety of industries and applications including but not limited to one or more of transportation, projectiles, high temperature applications, structural applications, nuclear applications, or corrosion resistance applications. Metallurgy of alloy or composite materials desired for extrusion or other processing can present various challenges. For example, joining magnesium to aluminum can be troublesome because of the formation of brittle, Mg₁₇Al₁₂, intermetallics (IMC) at a dissimilar interface. Conventional welding such as tungsten inert gas, electron beam, laser, resistance spot, and compound casting may generate thick, brittle, Mg₁₇Al₁₂ interfacial layers since both the magnesium and aluminum go through melting and solidification.

Fabrication of magnesium-bearing components may become much more widespread if lower-cost fabrication approaches are made viable. For example, in the automotive industry, cost is generally a barrier for using magnesium sheet materials. Unlike aluminum and steel, magnesium alloys cannot be hot-rolled easily in the as-cast condition due to a propensity for cracking. An approach of rolling magnesium alloys by twin roll casting process or using a multi-step hot rolling can make the sheet forming process expensive. Cold rolling is even more susceptible to cracking and is therefore limited to small reduction ratios (i.e., low throughput), which also makes the process slow and costly.

In the field of energy conversion and energy transport, there is a need to develop materials (e.g., alloys, composites, etc.) with improved electrical performance, specifically higher electrical conductivity and current density. In electrical applications, such as in overhead conductors, motors, inverters, and generators, copper and aluminum, and various alloys thereof, are desirable materials. These alloys (such as C10100, C11000, C15000, AA1100, AA1350, AA8002) may seek to have minimal impurities, but occasionally can benefit from additives that help improve one or more of mechanical performance, wear resistance, or corrosion resistance of the metal substrates, but certain approaches may involve sacrificing electrical conductivity. Introducing additives in a metal may increase charge scattering, which, in turn, can lead to detrimental electrical carrier transport properties. There is a need for technology in which additives can be introduced into a metal to make an alloy or composite for improving electrical performance.

The present techniques can help address one or more of the challenges mentioned above, such as producing feedstock for other processing or producing finished components. For example, the present techniques can help enable extrusion of metal wires, bars, or tubes. Hollow structures can have an easily specifiable—or even variable—thickness within the same extruded product. This extrusion process can yield extrusion products from lightweight materials, such as magnesium and aluminum alloys, with improved mechanical properties. The extrusion process can go directly to extrudate from powder, flake, or billet feedstocks in as few steps as a single step. This can help reduce the overall energy consumption and processing time for extrusion.

Combining linear compression and rotational shearing can result in lower extrusion force compared to certain other extrusion approaches. As an illustration, a size of any hydraulic ram, supporting components, mechanical structure, and overall footprint can be scaled down. This can help in enabling smaller production machinery. Plasticizing energy for extrusion can be provided via friction at the interface between the billet and a scroll-faced or other extrusion die. Such plastic shear deformation within the extruding material need not require the preheating and external heating of the billet material used by other methods, or such preheating can be significantly less energy intensive as compared to non-shear-assisted approaches. This reduces power consumption. Extrusion ratios up to 200:1 have been achieved for many alloys using the present techniques. This means that the present techniques can involve fewer to no repeat passes of the material through the extrusion machinery to achieve the final desired extrusion diameter. This can help lower production costs compared to certain other approaches to extrusion.

Devices for performing shear assisted extrusion to produce specifiable or variable thickness extrudate walls are also described. For example, an extrusion device can include a die tool. The die tool can include a die face. The die face can define a die face orifice. A central longitudinal axis can be defined as extending through the die face orifice, such as at a center of the die face orifice. The die tool can be configured to rotate about the central longitudinal axis and to be pressed against a billet (or vice versa). A mandrel can be extended through the die face orifice, such that an outer lateral dimension of the mandrel and an inner lateral dimension of the die face orifice can form an extrusion aperture. All or a portion of the mandrel can include a lateral outer dimension that can be tapered, such as to vary along a longitudinal direction. Moving the mandrel with respect to the die face orifice (or vice-versa) can vary a distance between the inner boundary of the die face orifice and the tapered outer boundary of mandrel. Thus, by moving the tapered portion of the mandrel with respect to the die face orifice, or vice versa, the annular width of the extrusion aperture can be specified or varied, which in turn can specify or vary the thickness of the extrudate, such as by specifying or varying a lateral outer dimension of the mandrel with respect to the die face orifice.

This Summary is an overview of some of the teachings of the present application and not intended to be an exclusive or exhaustive treatment of the present subject matter. Further details about the present subject matter are found in the detailed description and appended claims. Other aspects of the disclosure will be apparent to persons skilled in the art upon reading and understanding the following detailed description and viewing the drawings that form a part thereof, each of which are not to be taken in a limiting sense. The scope of the present disclosure is defined by the appended claims and their legal equivalents.

### BRIEF DESCRIPTION OF THE DRAWINGS

In the drawings, which are not necessarily drawn to scale, like numerals may describe similar components in different views. Like numerals having different letter suffixes may represent different instances of similar components. Various embodiments are illustrated by way of example in the figures of the accompanying drawings. Such embodiments are demonstrative and not intended to be exhaustive or exclusive embodiments of the present subject matter.

FIG. 1 illustrates, by way of example and not limitation, a system for extruding hollow cross-section pieces.

FIG. 2 illustrates, by way of example and not limitation, a system for extruding hollow cross-section pieces using a porthole die and rotationally fixed mandrel.

FIG. 3 illustrates, by way of example and not limitation, a system including a die tool, a tailstock portion, and a linear actuation device for extruding hollow cross-section pieces using a tapered mandrel.

FIG. 4 illustrates, by way of example and not limitation, a cutout of a portion of a system for extruding hollow cross-section pieces using a tapered mandrel.

FIG. 5 illustrates, by way of example and not limitation, a cutout of a portion of a system for extruding hollow cross-section pieces using a tapered mandrel.

FIG. 6 illustrates, by way of example and not limitation, a cutout of a portion of a system for extruding hollow cross-section pieces using a tapered mandrel.

FIG. 7 illustrates, by way of example and not limitation, a cutout of a portion of a system for extruding hollow cross-section pieces using a tapered mandrel.

FIG. 8 illustrates, by way of example and not limitation, a system for extruding hollow cross-section pieces using a tapered mandrel at a stage for removal of the tapered mandrel.

FIG. 9 illustrates, by way of example and not limitation, a cutout of a portion of a system for extruding hollow cross-section pieces using a tapered mandrel.

FIG. 10A illustrates, by way of example and not limitation, an example extruded product.

FIG. 10B illustrates, by way of example and not limitation, an example extruded product.

FIG. 11 illustrates, by way of example and not limitation, an example mandrel and rotation prevention component.

FIG. 12 illustrates, by way of example and not limitation, an example flowchart of a method for extruding hollow cross-section pieces.

### DETAILED DESCRIPTION

Shear assisted extrusion processes (ShAPE) are provided, such as for forming an extrudate with a specifiable or variable extrudate wall thickness. For example, a mandrel can be located with respect to an extrusion die, such as to form an annular extrusion aperture therebetween. A lateral dimension of the extrusion aperture can be easily established or adjusted, such as to a particular desired inner dimension that corresponds to a mandrel outer diameter that can be varied by adjusting a longitudinal position of the mandrel with respect to the extrusion die (or vice-versa). A billet of a billet material to be extruded can be placed in a container. A portion of the billet material within the container can be extruded through the extrusion aperture in response to a rotational shearing force and an axial extrusion force being applied to a face of a portion of billet material by the die tool. The particular inner diameter of the extrusion aperture can be established or adjusted by moving one of the mandrel or the die tool with respect to the other, either before and/or during shear-assisted processing and extrusion (ShAPE).

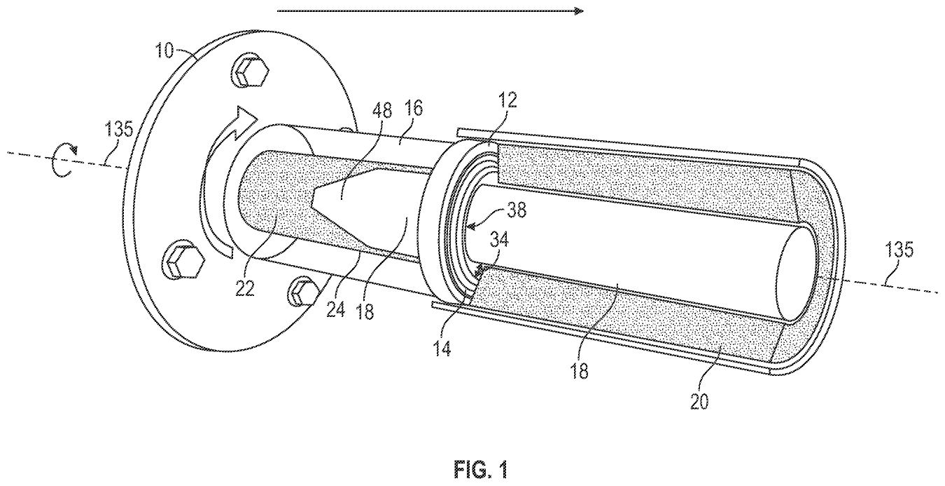

FIG. 1 illustrates a system for extruding hollow cross-section pieces. This can include using shear-assisted processes (ShAPE) involving applying an axial compression force and a rotational shearing force. As shown in FIG. 1, a rotating die 10 can include a die face 12 that can be thrust against and into a billet material 20 (or vice versa). The die face 12 can include one or more scrolls 14 (e.g., spiral structures protruding outward that direct plasticized material inward as the die face 12 rotates relative to the billet material 20), the die face 12 can include other surface morphology features, or it can even be flat. The rotating shear force and the longitudinal axial compressive force of the die face 12 and the die shank 16 can combine to plasticize the billet material 20 at the interface between the die face 12 and the billet material 20. The plasticized material can flow in a desired direction. Additionally or alternatively, the billet material 20 may spin and the die face 12 can be pushed axially into the billet material 20 such as to provide a combination of shear and compressive forces at the interface between the billet material 20 and the die face 12. Regardless of which structure is rotated or rammed relative to the other, the combination of the axial and the rotating forces can plasticize the billet material 20 at the interface with the die face 12. Flow of the plasticized material can then be directed, such as through an extrusion aperture, to another location. At the other location, a die bearing surface 24 of a specified length can facilitate reconstitution of the plasticized material into an arrangement in which a new and more refined grain size and texture control at the microscopic level can take place, thereby forming an extruded product 22 (also referred to as an “extrusion product” or an “extrudate”), such as can include one or more desired characteristics. The die face 12 can define a die face orifice 38. A longitudinal axis (or “central longitudinal axis”) 135 can be defined to extend through a center of the die face orifice 38. The rotating die 10 can rotate about the central longitudinal axis 135 to permit the die face 12 to engage the billet material 20.

The mandrel 18 can be in close proximity to the die face 12. Together with a die face orifice 38 in the die face 12, the mandrel 18 can form an annular extrusion aperture 34 that the plasticized extrusion material is extruded through to form the extruded product 22. The extrusion aperture can be formed when the mandrel 18 is extended through a die face orifice 38 in the die face 12.

By moving a tapered portion 48 of the mandrel 18 along a longitudinal axis 135 with respect to the die face orifice in the die face 12 (or vice versa), a cross-sectional profile width of the extrusion aperture can be adjusted. This can result in an adjustably specifiable inner lumen diameter or even a variable inner lumen diameter of the extruded product 22, as shown and described herein. Further, this approach has the potential to be a low-cost manufacturing technique that can be to fabricate a variety of articles, such as can use a variety of materials, and such as which can provide a variety of inner lumen diameters. As described herein, in addition to modifying various parameters such as feed rate, heat, pressure and spin rates of the process, various mechanical elements, such as varying an annulus width of an extrusion aperture and/or rotationally fixing the mandrel 18 while allowing for linear translation of a tapered portion 48 of the mandrel 18, can achieve various desired results.

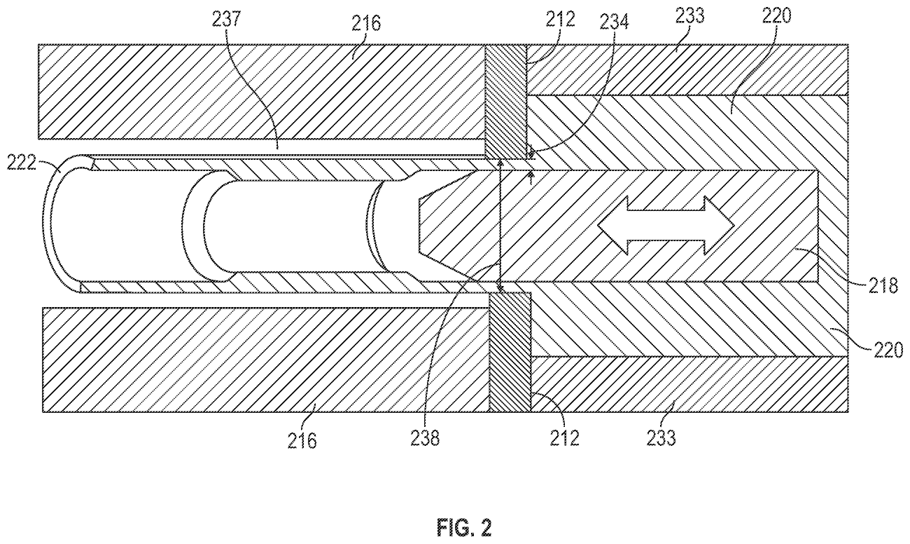

FIG. 2 illustrates a system for extruding hollow cross-section pieces using a tapered mandrel 218. The system in FIG. 2 includes a die shank 216 (analogous to die shank 16 in FIG. 1), and a die face 212 (analogous to die face 12 in FIG. 1). The die shank 216 and the die face 212 can be rotated about a longitudinal axis (such as longitudinal axis 135 in FIG. 1). The die face 212 can be brought into close proximity to a container 233 holding billet material 220 that encircles a mandrel 218. The rotation of the die face 212 in close proximity and/or engaged with the billet material 220, can cause the billet material 220 to plasticize, as described herein.

The mandrel 218 can include a tapered tip portion having a variable outer diameter or other outer lateral dimension. For example, the mandrel 218 can include a first diameter and a second diameter and a portion between the first diameter and the second diameter that has a tapered diameter from the first to the second diameter. The tapered tip portion of the mandrel 218 can create an extrusion aperture 234 that can have a specifiably-fixed or even a variable inner diameter based on a position (indicated by the illustrated double-sided arrow) of the mandrel 218 along the longitudinal axis, as it is moved distally away from or proximally toward the die face 212. The mandrel 218 can be tapered to have a smaller lateral profile toward a tip of the mandrel that extends distally into a die face orifice 238 than a lateral profile of a more proximal portion of the mandrel 218. In this way, the billet material 220 can be extruded through the extrusion aperture 234, resulting in an extruded product 222 with an inner lumen wall of variable diameter. In order to do this, as will be described further below, the mandrel 218 can move longitudinally along the longitudinal axis but can be inhibited or prevented from rotating about the longitudinal axis, such as by using an anti-rotation device that engages the mandrel and inhibits rotation even when the die face is rotating. This is in contrast to prior approaches of linear extrusion where an anti-rotation device is not used due to a lack of a rotational component to the force and therefore no use for preventing spinning of the mandrel. A gap 237 between the die shank 216 and the extruded product 222 can be present due to a lip in the die face 212 at the extrusion aperture 234. This gap 237 can be provided to help inhibit or prevent the extruded product 222 from scraping or riding along a side of the die shank 216. The mandrel 218 can be configured to extrude a first portion of plasticized billet material through the extrusion aperture 234 in response to the mandrel 218 being at a first position that corresponds to a first extrusion aperture dimension.

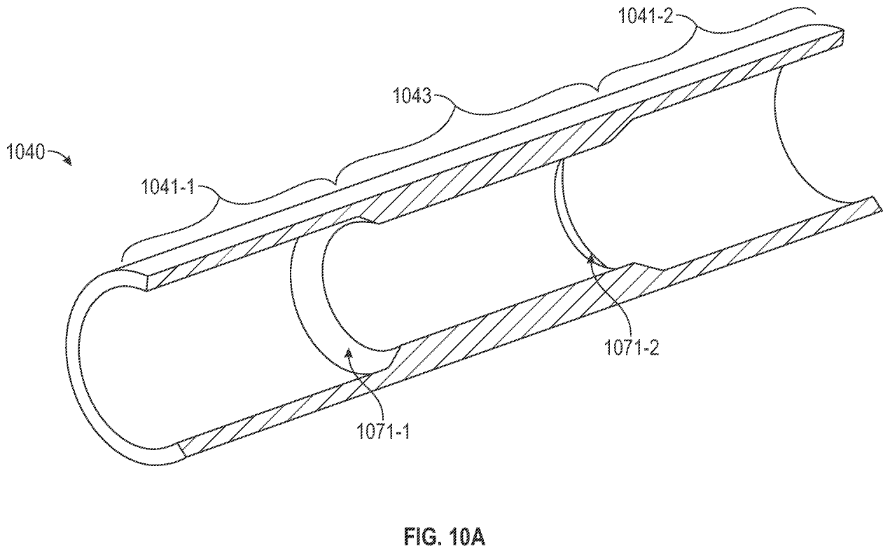

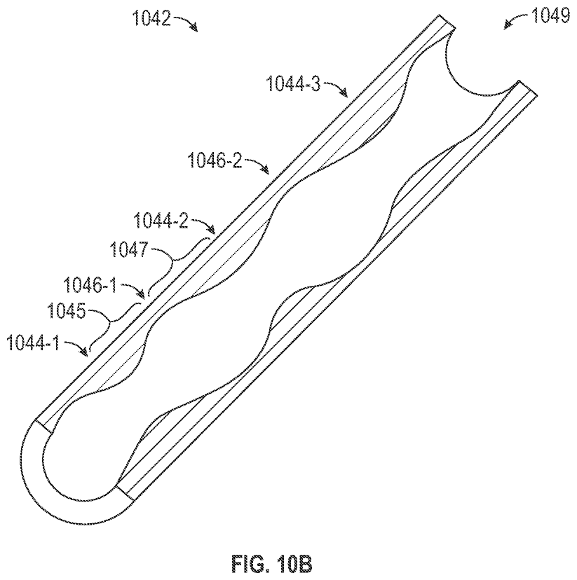

In some embodiments, the mandrel 218 can be moved to a desired location with respect to the die face orifice 238, and the billet 220 is extruded in a fixed, and not variable, diameter. In this example, the mandrel 218 may not move with the billet 220, and does not move longitudinally with respect to the container, but is moveable and fixable to specify the desired size of the die face orifice 238 to result in a specifiable fixed inner diameter of the extrudate. Further, in the example of the variable (e.g., undulating) inner diameter or fixed inner diameter of the extrusion aperture 234, the mandrel 218 is able to move independently of the container 233 that in turn moves the billet 220. In some examples, a control system can include a controller and circuitry and/or hardware or firmware to adjust the longitudinal position of the mandrel 218. Adjustment of the longitudinal position of the mandrel 218 can achieve the desired inner diameter of the extrusion aperture 234 (and therefore the diameter of the extruded product) and/or to fix the position of the mandrel 218 during extrusion once the desired position is achieved, thereby causing a uniform and straight inner lumen wall of the extruded product. Further, the control system can adjust the position of the mandrel 218 during extrusion to cause a tapered diameter along the inner diameter of the extruded product, as will be described in association with FIGS. 10A and 10B below.

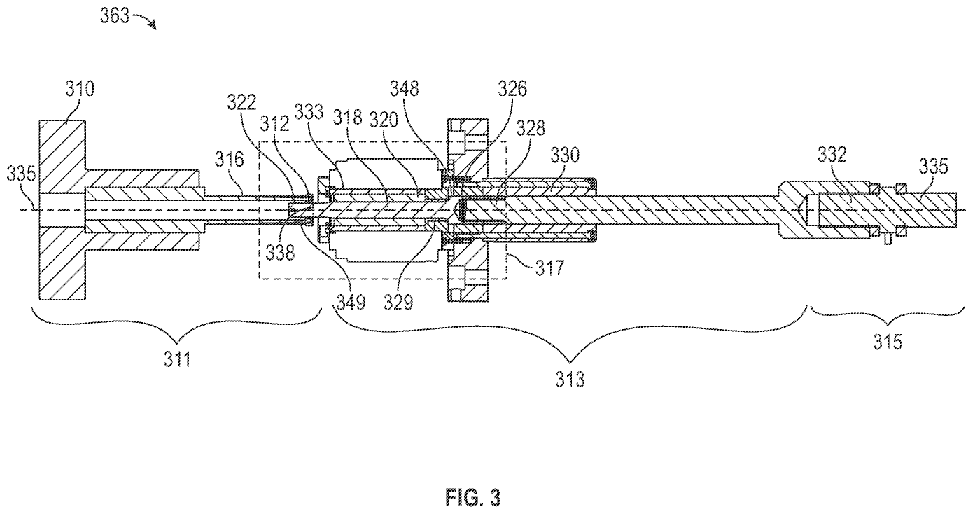

FIG. 3 illustrates a system 363 including a die portion 311, a tailstock portion 313, and a linear actuation device 315 for extruding hollow cross-section pieces using a mandrel 318 that is tapered. The die portion 311 includes a rotating die holder 310, a die shank 316, and a die face 312. The rotating die holder 310, the die shank 316, and the die face 312 can each be fixedly coupled to each other and rotate about a longitudinal axis 335 of the rotating die portion 311.

The tailstock portion 313 can include a container 333 used to hold a billet material 320. The mandrel 318 can be encircled by the billet material 320 and move longitudinally along the longitudinal axis 335 while being prevented from rotating about the longitudinal axis 335. The mandrel 318 can move independent of the container 333 when moving longitudinally along the longitudinal axis 335, and therefore also independent of the billet material 320. The mandrel 318 can include a threaded or other connector portion 326 used to connect the mandrel 318 to a stem 328. The mandrel 318 can be in contact with a linear bearing 330 or other anti-rotation mechanism that inhibits the mandrel 318 from rotating about the longitudinal axis 335 while still moveable distally away from or proximally toward a die face 312 along the longitudinal axis 335. The linear bearing 330 can provide support for the stem 328 and other structures in contact with or close proximity to the linear bearing 330 in addition to preventing rotation of the mandrel 318. The tailstock portion 313 can include a sleeve bearing 329 in contact with the mandrel 318 and the billet material 320, as illustrated. The sleeve bearing 329 is a bearing structure that is in contact with the mandrel 318 and container 333, allowing for the mandrel 318 to translate without allowing billet material 318 to reverse-extrude in an undesirable direction.

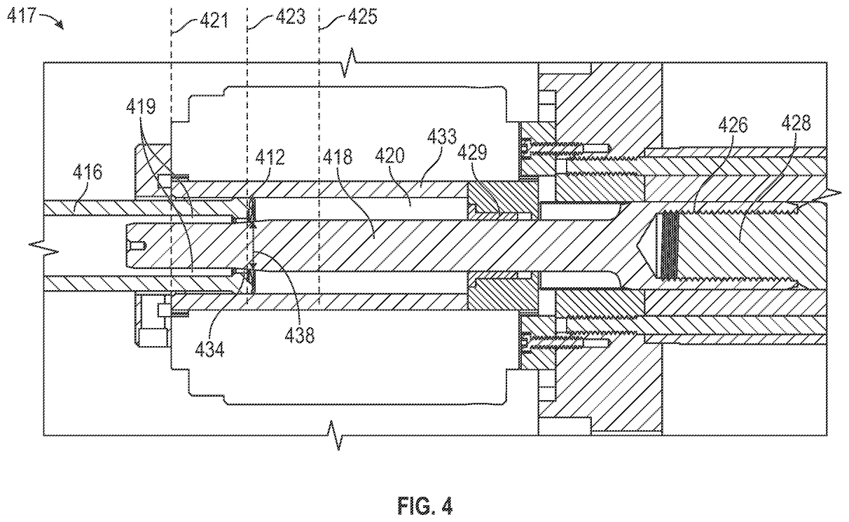

A linear actuation device 315 can be in contact with the stem 328 such as through a shaft that is used to move the mandrel 318 along the longitudinal axis 335. Optionally a force measurement device 332 can be used to couple the linear actuation device 315 to the stem 328 and provide process force measurements. The mandrel 318 can be engaged with the linear actuation device 315 at a first end 348 of the mandrel 318 opposite a second end 349. The second end can be configured to be in contact with the billet material 320. The linear actuation device 315 can be controlled and/or operated by control circuitry used to determine a position of the mandrel 318 in particular a position of a tapered portion of the mandrel that is located within a die face orifice 338 and defining a corresponding inner diameter of the extrusion aperture (such as extrusion aperture 234 in FIG. 2). A cutout 317 illustrates a portion of the system of FIG. 3 that is further described in association with FIGS. 4-7, with the mandrel 318 at different longitudinal positions along the longitudinal axis 335 and therefore with differing extrusion aperture inner diameters.

FIG. 4 illustrates a cutout 417 of a portion of a system for extruding hollow cross-section pieces using a mandrel 418. The cutout 417 illustrates a die shank 416, and a die face 412, which are analogous to the die shank 316 and die face 312 in FIG. 3. The container 433 is used to hold a billet material within a billet region 420 (billet material not illustrated in FIG. 4 for ease of illustration). The mandrel 418 can be encircled by the billet material in the billet region 420 and can move longitudinally along the longitudinal axis 335 while being prevented from rotating about the longitudinal axis 335. The mandrel 418 can include a connector portion 426 used to connect the mandrel 418 to a stem 428. A sleeve bearing 429 can be in contact with the mandrel 318 and the billet material 320, as illustrated.

While applying a rotational shearing force by the die face 412 on the billet material in the billet region 420, a plasticized extrusion material can be extruded through the extrusion aperture 434 to form the extrusion product 419. The extrusion aperture 434 can have an intermediate inner diameter as the die face 412 is positioned in proximity to the mandrel 418 at a taper of the mandrel 418 between a first location 421 of the mandrel 418 with a smaller diameter and a second location 425 of the mandrel 418 with a larger diameter. As an example, the inner diameter of the extrusion aperture 434 is adjustable by moving the mandrel 418 longitudinally along the longitudinal axis (e.g., such as longitudinal axis 335 in FIG. 3) to move the die face 412 into closer proximity to a specific location on a tapered portion of the mandrel 418 that causes a specified inner diameter of the extrusion aperture.

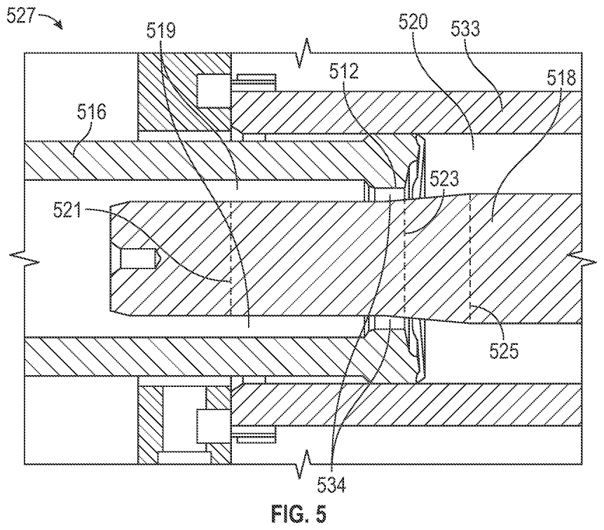

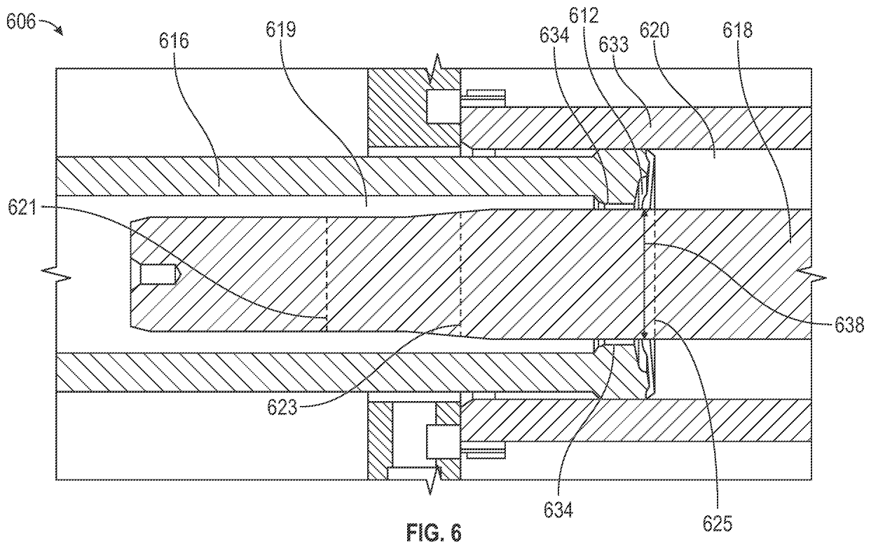

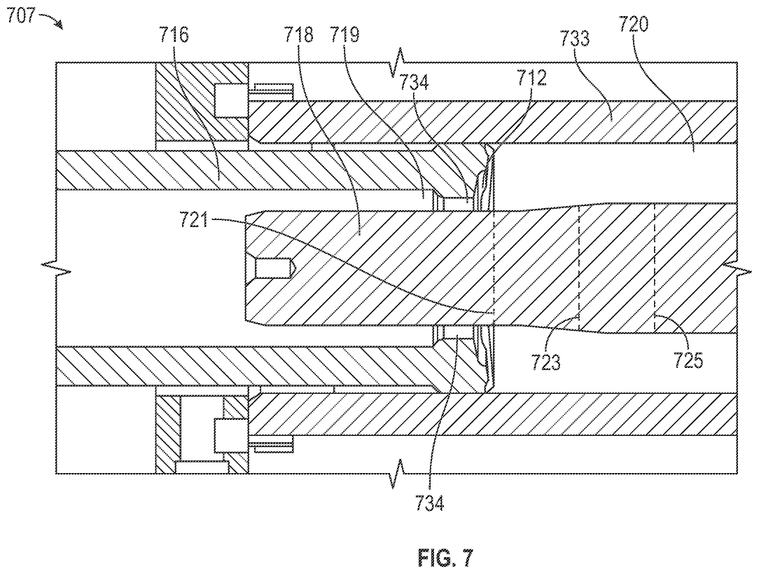

The outer diameter of the extrusion aperture 434 can be defined by the location of the die face 412, or rather the inner diameter of the die face orifice 438, which can remain constant in this example. While two diameters with a tapered portion of the mandrel 418 are illustrated, any number of diameters and progression from one diameter to another diameter can be implemented, such as a linear taper, a non-linear taper, etc. A closer view of the die face 412 in close proximity to the tapered portion of the mandrel 418 is illustrated in and described in association with FIG. 5. The die face 412 in close proximity to the second location 425 of the mandrel 418 is illustrated in and described in association with FIG. 6. The die face 412 in close proximity to the first location 421 of the mandrel 418 is illustrated in and described in association with FIG. 7.

FIG. 5 illustrates a cutout 527 of a portion of a system for extruding hollow cross-section pieces using a mandrel. The cutout 527 illustrates a die shank 516, and a die face 512, which are analogous to the die shank 416 and die face 412 in FIG. 4. The container 533 is used to hold a billet material within a billet region 520 (billet material not illustrated in FIG. 5 for ease of illustration). The mandrel 518 can be encircled by the billet material in the billet region 520 and move longitudinally along the longitudinal axis (such as longitudinal axis 335 in FIG. 3) while being prevented from rotating about the longitudinal axis.

During application of a rotational shearing force by the die face 512 on the billet material in the billet region 520, plasticized billet material can be extruded through the extrusion aperture 534 and move to the extruded product location 519. Similar to FIG. 4, the extrusion aperture 534 can be at an intermediate inner diameter as the die face 512 is positioned in proximity to the mandrel 518 at a taper (e.g., at location 523) of the mandrel 518 between a first location 521 of the mandrel 518 with a smaller diameter and a second location 525 of the mandrel 518 with a larger diameter. As an example, the inner diameter of the extrusion aperture 534 is adjustable by moving the mandrel 518 longitudinally along the longitudinal axis (e.g., such as longitudinal axis 335 in FIG. 3) to move the die face 512 into closer proximity to a specific portion of the mandrel 518 that causes a specified inner diameter of the extrusion aperture.

FIG. 6 illustrates a cutout 606 of a portion of a system for extruding hollow cross-section pieces using a mandrel. The cutout 606 illustrates a die shank 616, and a die face 612, which are analogous to the die shank 416 and die face 412 in FIG. 4. The container 633 is used to hold a billet material within a billet region 620 (billet material not illustrated in FIG. 6 for ease of illustration). The mandrel 618 can be encircled by the billet material in the billet region 620 and move longitudinally along the longitudinal axis (such as longitudinal axis 335 in FIG. 3) while being prevented from rotating about the longitudinal axis. The mandrel 618 can be moved longitudinally independently of movement of the container 633 and the die face 412 and/or die face orifice 438 such that movement of the mandrel 618 results in adjustment of the diameter of the extrusion aperture 634. Once the desired diameter of the extrusion aperture 634 is achieved, the mandrel 618 can be fixed in place relative to the die face 412 during extrusion to keep a constant diameter thickness of the inner lumen wall of the extruded product or the mandrel 618 can be adjusted at a particular rate to achieve a rate of change of diameter (or corresponding change per unit length of extrudate) along the inner lumen wall of the extruded product.

While applying a rotational shearing force by the die face 612 on the billet material in the billet region 620, a plasticized extrusion material can be extruded through the extrusion aperture 634 to form the extrusion product at a location 619 alongside the mandrel 518. In this example illustrated in FIG. 6, the diameter of the mandrel 618 at the second location 625 is larger thereby causing the inner diameter of the extrusion aperture 634 to be smaller. The smaller inner diameter of the extrusion aperture 634 causes the extruded product to have a thinner diameter, as well. However, as an example, the inner diameter of the extrusion aperture 634 is adjustable to a larger inner diameter (e.g., at first location 621) by moving the mandrel 618 longitudinally along the longitudinal axis (e.g., such as longitudinal axis 335 in FIG. 3) to move the die face 612 into closer proximity to a specific portion of the mandrel 618 that is smaller in diameter, causing a transition or taper (such as at location 623) from a smaller diameter of the extruded product to a larger diameter of the extruded product, as will be further illustrated in association with FIGS. 10A and 10B.

FIG. 7 illustrates a cutout 707 of a portion of a system for extruding hollow cross-section pieces using a mandrel. The cutout 707 illustrates a die shank 716, and a die face 712, which are analogous to the die shank 416 and die face 412 in FIG. 4. The container 733 is used to hold a billet material within a billet region 720 (billet material not illustrated in FIG. 7 for ease of illustration). The mandrel 718 can be encircled by the billet material in the billet region 720 and move longitudinally along the longitudinal axis (such as longitudinal axis 335 in FIG. 3) while being prevented from rotating about the longitudinal axis.

While applying a rotational shearing force by the die face 712 on the billet material in the billet region 720, a plasticized extrusion material can be extruded through the extrusion aperture 734 to form the extrusion product at a location 719 alongside the mandrel 718. In this example illustrated in FIG. 7, the diameter of the mandrel 718 at the first location 721 is smaller, than the diameter at the second location 725, with this larger diameter at the second location 725 thereby causing the inner diameter of an annulus defining the extrusion aperture 734 to be larger. The larger inner diameter of the extrusion aperture 734 causes the extruded product to have a larger diameter, as well. However, as an example, the inner diameter of the annulus defining the extrusion aperture 734 is adjustable to a smaller inner diameter by moving the mandrel 718 longitudinally along the longitudinal axis (e.g., such as longitudinal axis 335 in FIG. 3) to move the die face 712 into closer proximity to a specific portion of the mandrel 718 that is smaller in diameter, causing a transition or taper from a larger inner diameter of the extruded product to a smaller inner diameter of the extruded product, as will be further illustrated in association with FIGS. 10A and 10B.

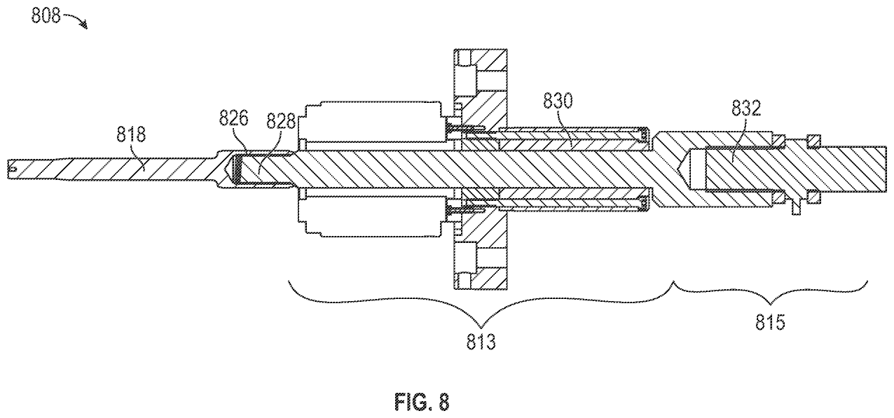

FIG. 8 illustrates a system 808 for extruding hollow cross-section pieces using a tapered mandrel at a stage for removal of a mandrel 818. The system 808 includes a tailstock portion 813 and a linear actuation device 815. The tailstock portion 813 includes a connector portion 826, a stem 828, and a linear bearing 830. The linear actuation device 815 includes a force measurement device 832.

The mandrel 818 can be moved linearly along a longitudinal axis (such as longitudinal axis 335 in FIG. 3) to move the mandrel 818 sufficiently outside the tailstock portion 813 and thereby sufficiently outside a container (such as container 433 in FIG. 4). The mandrel 818 can then be removed from the stem 828 by disconnecting the mandrel 818 from the connector portion 826. In this example, the connector portion 826 can be a threaded connector and the mandrel 818 can be twisted off the threads to remove the mandrel 818. The mandrel 818 can then be replaced by a different mandrel before proceeding to extrude an additional extrusion product. In some examples, prior to removal of the mandrel 818, the mandrel 818 can be moved longitudinally relative to the rotating die (such as rotating die 310 in FIG. 3) to pinch or shear off the extrudate by closing the extrusion aperture.

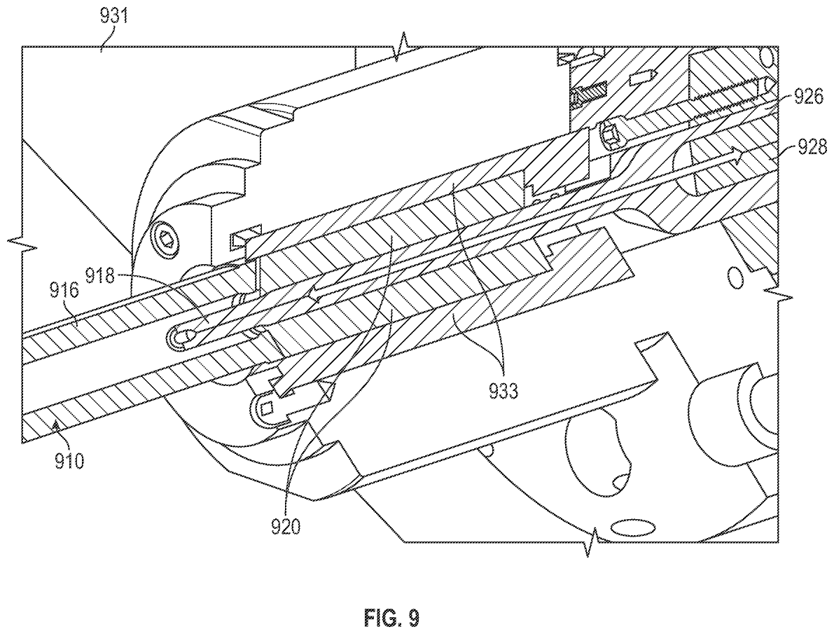

FIG. 9 illustrates a cutout of a portion of a system for extruding hollow cross-section pieces using a mandrel 918. The portion of the system includes a crosshead 931 that includes a container 933. The container 933 contains a billet material 920. A mandrel 918 is encircled by the billet material 920 but can move longitudinally along a longitudinal axis (such as longitudinal axis 335 in FIG. 3) separate from the billet material 920. The mandrel 918 includes a connector portion 926 and a stem 928. A rotating die 910 and a die shank 916 are configured to push against the billet material 920 while rotating either the die shank 916 or the billet material 920 and container 933.

FIG. 10A illustrates an example extruded product 1040. The example shear-assisted extrusion product 1040 can include portions of varying diameters. For example, a first set of portions 104-1, 104-2 can be a first thickness (e.g., 1 mm between an inner diameter and an outer diameter) and a second set of portions 1043 can be a second thickness (e.g., 2 mm between an inner diameter and an outer diameter). The first set of portions 1041-1, 1041-2 can be produced while an extrusion aperture, such as the extrusion aperture 434 in FIG. 4, is smaller in diameter than when the second set of portions 1043 is produced. As an example, the first portions 1041-1, 1041-2 may be produced while the extrusion aperture 634 of FIG. 6 is being used and the second set of portions 1043 may be produced while the extrusion aperture 734 of FIG. 7 is being used. A respective transition region 1071-1, 1071-2 between the first set of portions 1041-1/1041-2 and second set of portions 1043 exists, which may be either gradual or abrupt.

FIG. 10B illustrates an example shear-assisted extrusion product 1042. The example shear-assisted extrusion product 1042 can include a first set of portions 1044-1, 1044-2, 1044-3 at a first thickness and a second set of portions 1046-1, 1046-2 at a second thickness. The shear-assisted extrusion product 1042 can have an opening of a tube 1049. The first thickness can be greater than the second thickness, as is illustrated in FIG. 10B. A decreasing taper of thickness 1045 can occur when extruding the portion of the shear-assisted extrusion product 1042 and going from the portion 1044-1 of the first set to the portion 1046-1 of the second set. Put another way, the taper can go from a greater thickness to a lesser thickness. In some examples, a first portion of the shear-assisted extrusion product 1042 can include a tapering angle such that the tapering from the first diameter of the first portion to a second diameter of a second portion varies at a particular fixed rate per distance or at an adjustable rate per distance. And vice versa, an increasing taper of thickness 1047 can occur when extruding the portion of the shear-assisted extrusion product 1042 and going from the portion 1046-1 of the second set to the portion 1044-2 of the first set. Put another way, the taper can go from a lesser thickness to a greater thickness.

These increasing and decreasing tapering portions can be beneficial for creating extrusion products with “crumple zones” or similar specified locations of particular strength and other specified locations of weaknesses. As an example, the shear-assisted extrusion product 1042 can preferentially crumple at the specified locations of differing stiffness upon receiving pressure at a particular end of the extruded product, which can help absorb at least some impact energy received at one end of the extruded product such that the impact energy is attenuated at the other end of the extruded product or otherwise dissipated through deformation. Each of the portions with a lesser thickness may collapse prior to the portions with greater thickness, providing an advantage to the structure, particularly in the automotive and aeronautical industries. Such preferential crumpling or deformation can help to dissipate energy in vehicular collisions or reduce a likelihood of penetration of an occupied region of a vehicle cab during a collision, or both.

The shear-assisted extrusion product 1042 can include a tube 1049 defining an inner lumen having a length, as illustrated. The tube 1049 can have a fixed outer diameter and the inner lumen can define a varying inner diameter along the length of the inner lumen. The shear-assisted extrusion product 1042 can include at least one of aluminum, an aluminum alloy, magnesium, a magnesium alloy, or a combination thereof. The tube 1042 can include a wall thickness including alternating relatively thinner and thicker portions, as illustrated.

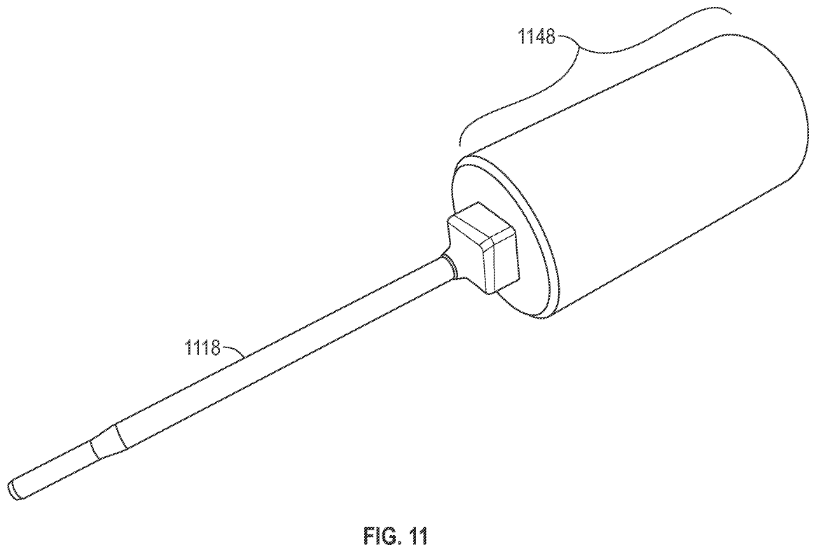

FIG. 11 illustrates an example of a mandrel 1118 and rotation prevention component (e.g., a linear bearing) 1148. The mandrel 1118 can be coupled to the rotation prevention component 1148. The rotation prevention component 1148 can prevent the mandrel 1118 from rotating relative to a billet and container when moving longitudinally along a longitudinal axis (such as longitudinal axis 335 in FIG. 3). The rotation prevention component 1148 can include a bushing. In some examples, the rotation prevention component can include a non-circular profile that is uniform along a length of its side and/or additional configurations configured to engage with the mandrel to inhibit or prevent the mandrel from rotating. Such configurations can include features such as a set screw, pin, protruding keying feature or channel defining a keyway in the mandrel for engagement with a corresponding bore or channel to provide mechanical coupling that inhibits relative rotation of the mandrel and a driving stem or pushrod versus a container housing the billet.

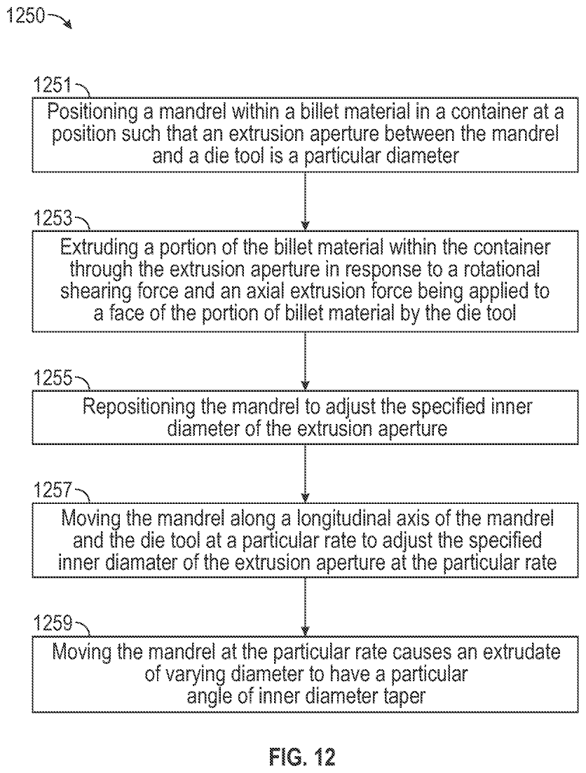

FIG. 12 illustrates, by way of example and not limitation, a method 1250 of providing an adjustable or variable wall extrusion. The method 1250 may be carried out using an extrusion system such as the systems described in association with FIGS. 1 to 9. Various examples are illustrated in the figures above. One or more features from one or more of these examples may be combined to form other examples.

At 1251, the method 1250 can include positioning a mandrel within a billet material in a container at a position such that an extrusion aperture between the mandrel and a die tool has a specified inner diameter. The mandrel can include a lateral outer dimension that varies along a longitudinal direction to vary an inner boundary of the extrusion aperture. The position of the mandrel in relation to a diameter of the mandrel can determine an inner diameter of the extrusion aperture.

At 1253, the method 1250 can include extruding a portion of the billet material within the container through the extrusion aperture in response to a rotational shearing force and an axial extrusion force being applied to a face of the portion of billet material by the die tool. The specified inner diameter of the extrusion aperture varies in response to movement of the mandrel with respect to the die tool along a longitudinal axis (such as longitudinal axis 335 in FIG. 3) of the die tool.

At 1255, the method 1250 can include repositioning the mandrel to adjust the specified inner diameter of the extrusion aperture. At 1257, the method 1250 can include moving the mandrel along a longitudinal axis (such as longitudinal axis 335 in FIG. 3) of the mandrel and the die tool at a particular rate to adjust the specified inner diameter of the extrusion aperture at the particular rate. At 1259, the method 1250 can include moving the mandrel at the particular rate to cause an extrudate of varying diameter to have a particular angle of diameter taper.

This process can help enable better strength, ductility, and corrosion resistance at the macroscopic level together with increased and better performance. This process can help reduce or eliminate the need for additional heating. The process can use any of a variety of forms of material including billet, powder, or flake without the need for extensive preparatory processes such as “steel canning”, billet preheating, de-gassing, de-canning, or the like. This arrangement can also help provide a methodology for performing other steps such as cladding, enhanced control for through wall thickness and other characteristics, joining of dissimilar materials and alloys, and may be used to provide feedstock materials for subsequent operations such as rolling.

As discussed above, ShAPE generally involves engagement of a die tool with a billet material as a feedstock to produce an extrudate. For example, the die tool can use spiral grooves on a die face to feed material inward through a die and around a mandrel that is traveling in the same direction as the extrudate. As such, a much larger outer diameter and extrusion ratio are possible as compared to other approaches, the material has a controlled wall thickness (that can be varied using the techniques described herein), the extrudate is free to push off the mandrel as in other extrusion techniques, and the extrudate length is limited only by feedstock volume. Accordingly, ShAPE can be scaled to suit higher-volume production.

The method examples described herein may be machine or computer-implemented at least in part. Some examples may include a computer-readable medium or machine-readable medium encoded with instructions operable to configure an electronic device or system to perform methods as described in the above examples. An implementation of such methods may include code, such as microcode, assembly language code, a higher-level language code, or the like. Such code may include computer readable instructions for performing various methods. The code may form portions of computer program products. Further, the code may be tangibly stored on one or more volatile or non-volatile computer-readable media during execution or at other times.

An example (e.g., “Example 1”) of a system can include a die tool including a die face defining a die face orifice and a central longitudinal axis extending through the die face orifice. The die tool may be configured to have relative rotational motion about the central longitudinal axis to engage with a billet. The system can include a mandrel that forms an extrusion aperture when extended through the die face orifice. The mandrel can include a lateral outer dimension that varies along a longitudinal direction to vary an inner boundary of the extrusion aperture in response to movement of the mandrel with respect to the die tool along the central longitudinal axis.

In Example 2, the subject matter of Example 1 optionally includes that the mandrel can be prevented from rotating about the central longitudinal axis while moving linearly along the central longitudinal axis.

In Example 3, the subject matter of any of Examples 1 or 2 optionally includes a rotation prevention component that can include a non-circular profile that is configured to engage with the mandrel to prevent the mandrel from rotating.

In Example 4, the subject matter of any of Examples 1 through 3 optionally includes that the mandrel is tapered to have a smaller lateral profile toward a tip of the mandrel that extends distally into the die face orifice than a lateral profile of a more proximal portion of the mandrel.

In Example 5, the subject matter of any of Examples 1 through 4 optionally includes that the die tool and the mandrel can be configured to extrude a first portion of an extrudate through the extrusion aperture in response to the mandrel being at a first position that correlates with a first extrusion aperture dimension.

In Example 6, the subject matter of any of Examples 1 through 5 optionally includes a rotation prevention component where the rotation prevention component can be a bushing engaged with the mandrel to prevent the mandrel from rotating.

In Example 7, the subject matter of any of Examples 1 through 6 optionally includes that the mandrel includes a first portion of the mandrel and a second tapering portion with a diameter that tapers from a first diameter of a first portion of the mandrel to a second diameter of a third portion of the mandrel.

In Example 8, the subject matter of Example 7 optionally includes that the tapering diameter of the first portion increases linearly from the first diameter to the second diameter.

In Example 9, the subject matter of any of Examples 7 or 8 optionally includes that the first portion comprises a tapering angle such that the tapering from the first diameter to the second diameter varies at a particular variable rate per distance.

In Example 10, the subject matter of any of Examples 1 through 9 optionally includes that the mandrel can be configured to move longitudinally to vary a tapered portion of the mandrel with respect to the die face orifice.

In Example 11, the subject matter of Example 10 optionally includes that the mandrel is configured to move longitudinally at a fixed or variable rate per distance.

In Example 12, the subject matter of Example 11 optionally includes that a position along the mandrel determines a diameter of an extrudate generated by extruding the billet through the extrusion aperture.

In Example 13, the subject matter of any of Examples 1 through 12 optionally includes that the mandrel is configured to move longitudinally relative to the die tool to pinch or shear off an extrudate by closing the extrusion aperture.

In Example 14, the subject matter of any of Examples 1 through 13 optionally includes a tailstock portion and a linear activation device. The tailstock portion can include a container configured to contain the billet. The linear actuation device can be coupled to the mandrel of the tailstock portion. The linear actuation device can be configured to cause linear movement of the mandrel along the central longitudinal axis.

In Example 15, the subject matter of Example 14 optionally includes that the linear actuation device is configured to move the mandrel along the central longitudinal axis in a direction of the die tool such that at least a portion of the mandrel is outside the container. The mandrel can be configured to be removed from the linear actuation device subsequent to being outside the container.

In Example 16, an example of an article of manufacture can include a shear-assisted extrusion product. The shear-assisted extrusion produce can include a tube defining an inner lumen having a length, the tube having a fixed outer diameter, the inner lumen defining a varying inner diameter along the length of the inner lumen.

In Example 17, the subject matter of Example 16 optionally includes that at least one of aluminum, an aluminum alloy, magnesium, a magnesium alloy, or a combination thereof.

In Example 18, the subject matter of Examples 16 through 17 optionally includes that the tube includes a wall thickness comprising alternating relatively thinner and thicker portions.

In Example 19, an example of a method can include positioning a mandrel within a billet material in a container at a position such that an extrusion aperture between the mandrel and a die tool is a specified inner diameter. The mandrel can include a lateral outer dimension that varies along a longitudinal direction to vary an inner boundary of the extrusion aperture. The example of a method can include extruding a portion of the billet material within the container through the extrusion aperture in response to a rotational shearing force and an axial extrusion force being applied to a face of the portion of billet material by the die tool. The specified inner diameter of the extrusion aperture can vary in response to movement of the mandrel with respect to the die tool along a longitudinal axis of the die tool.

In Example 20, the subject matter of Example 19 optionally includes repositioning the mandrel to adjust the specified inner diameter of the extrusion aperture.

In Example 21, the subject matter of Example 20 optionally includes repositioning of the mandrel comprises moving the mandrel along a longitudinal axis of the mandrel and the die tool at a particular rate to adjust the specified inner diameter of the extrusion aperture at the particular rate.

In Example 22, the subject matter of Example 21 optionally includes moving the mandrel at the particular rate causes an extrudate of varying inner diameter to have a particular angle of inner diameter taper.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The above detailed description is intended to be illustrative, and not restrictive. The scope of the disclosure should, therefore, be determined with references to the appended claims, along with the full scope of equivalents to which such claims are entitled.

What is claimed is:

1. A system, comprising:
a die tool, comprising a die face defining a die face orifice and a central longitudinal axis extending through the die face orifice, the die tool configured to have relative rotational motion about the central longitudinal axis to engage with a billet; and
a mandrel that forms an extrusion aperture when extended through the die face orifice, the mandrel including a lateral outer dimension that varies along a longitudinal direction to vary an inner boundary of the extrusion aperture in response to movement of the mandrel with respect to the die tool along the central longitudinal axis.

2. The system of claim 1, wherein the mandrel is prevented from rotating about the central longitudinal axis while moving linearly along the central longitudinal axis.

3. The system of claim 2, comprising a rotation prevention component comprising a non-circular profile that is configured to engage with the mandrel to prevent the mandrel from rotating.

4. The system of claim 1, wherein the mandrel is tapered to have a smaller lateral profile toward a tip of the mandrel that extends distally into the die face orifice than a lateral profile of a more proximal portion of the mandrel.

5. The system of claim 1, wherein the die tool and the mandrel are configured to extrude a first portion of an extrudate through the extrusion aperture in response to the mandrel being at a first position that correlates with a first extrusion aperture dimension.

6. The system of claim 1, comprising a rotation prevention component and the rotation prevention component is a bushing engaged with the mandrel to prevent the mandrel from rotating.

7. The system of claim 1, wherein the mandrel comprises a first portion of the mandrel and a second tapering portion with a diameter that tapers from a first diameter of a first portion of the mandrel to a second diameter of a third portion of the mandrel.

8. The system of claim 7, wherein the tapering diameter of the first portion increases linearly from the first diameter to the second diameter.

9. The system of claim 7, wherein the first portion comprises a tapering angle such that the tapering from the first diameter to the second diameter varies at a particular variable rate per distance.

10. The system of claim 1, wherein the mandrel is configured to move longitudinally to vary a tapered portion of the mandrel with respect to the die face orifice.

11. The system of claim 10, wherein the mandrel is configured to move longitudinally at a fixed or variable rate per distance.

12. The system of claim 11, wherein a position along the mandrel determines a diameter of an extrudate generated by extruding the billet through the extrusion aperture.

13. The system of claim 1, wherein the mandrel is configured to move longitudinally relative to the die tool to pinch or shear off an extrudate by closing the extrusion aperture.

14. The system of claim 1, comprising:
a tailstock portion, the tailstock portion comprising a container configured to contain the billet; and
a linear actuation device coupled to the mandrel of the tailstock portion, wherein the linear actuation device is configured to cause linear movement of the mandrel along the central longitudinal axis.

15. The system of claim 14, wherein:
the linear actuation device is configured to move the mandrel along the central longitudinal axis in a direction of the die tool such that at least a portion of the mandrel is outside the container; and
the mandrel is configured to be removed from the linear actuation device subsequent to being outside the container.

16. An article of manufacture, comprising:
a shear-assisted extrusion product, comprising a tube defining an inner lumen having a length, the tube having a fixed outer diameter, the inner lumen defining a varying inner diameter along the length of the inner lumen.

17. The article of manufacture of claim 16, comprising at least one of aluminum, an aluminum alloy, magnesium, a magnesium alloy, or a combination thereof.

18. The article of manufacture of claim 16, wherein the tube includes a wall thickness comprising alternating relatively thinner and thicker portions.

19. A method, comprising:
positioning a mandrel within a billet material in a container at a position such that an extrusion aperture between the mandrel and a die tool is a specified inner diameter, wherein the mandrel comprises a lateral outer dimension that varies along a longitudinal direction to vary an inner boundary of the extrusion aperture; and
extruding a portion of the billet material within the container through the extrusion aperture in response to a rotational shearing force and an axial extrusion force being applied to a face of the portion of billet material by the die tool, wherein the specified inner diameter of the extrusion aperture varies in response to movement of the mandrel with respect to the die tool along a longitudinal axis of the die tool.

20. The method of claim 19, comprising repositioning the mandrel to adjust the specified inner diameter of the extrusion aperture.

21. The method of claim 20, wherein repositioning of the mandrel comprises moving the mandrel along a longitudinal axis of the mandrel and the die tool at a particular rate to adjust the specified inner diameter of the extrusion aperture at the particular rate.

22. The method of claim 21, wherein moving the mandrel at the particular rate causes an extrudate of varying inner diameter to have a particular angle of inner diameter taper.
